(19) United States
(12) Patent Application Publication
(10) Pub. No.: US 2003/0225588 A1
(43) Pub. Date: Dec. 4, 2003

(54) Business method including sales of an intangible product to automobile dealers

(76) Inventors: Karey Davidson, Burlington (CA); Tracy White, Toronto (CA); Kelly Tingle, Burlington (CA); Maria Maffia, Oakville (CA)

Correspondence Address: HOFBAUER ASSOCIATES, SUITE 205 NORTH, 1455 LAKESHORE ROAD, BURLINGTON, ON, L7S 2J1, CA

(21) Appl. No.: 10/161,226

(22) Filed: Jun. 1, 2002

(51) Int. Cl. G06F 17/60

(52) U.S. Cl. 705/1

(57) ABSTRACT

A business method is disclosed wherein a warranty against theft is sold by a vendor to an automotive dealer for substantially each vehicle in its inventory, the warranty being in favour of the dealer and its assigns and cancellable, for full credit, by the dealer if it is made the subject of a dealer trade. In order for the warranty to be in effect, the dealer must apply indicia to the windows of the vehicle when it enters inventory, and must attempt to charge vehicle purchasers a fee. The vendor arms the dealer with material describing the likelihood of a vehicle being stolen and which explains the steps taken by the dealer to obtain the benefit of the warranty for the purchaser, specifically, the etching service, and the benefits afforded by the warranty.

### FIELD OF THE INVENTION

The present invention relates to products sold by automotive dealers in combination with vehicles, and, more specifically, relates to a business method wherein intangible products are sold to automotive dealers, wherein said dealers are instructed in methods for charging automobile purchasers a fee for products and'services provided to the purchasers, which includes the benefits of the products, and wherein said dealers are provided with an administration system for such products.

### BACKGROUND OF THE INVENTION

The permanent affixation of identification indicia on automotive vehicles, typically by etching the windows thereof, is currently understood to be a desirable method for limiting the likelihood of vehicle theft, since inter alia such indicia are readily visible to law enforcement authorities. Despite this desirability, vehicle manufacturers have not yet adopted window etching, possibly because said ready visibility arguably detracts mildly from overall vehicle appearance, in combination with costs relating the labour for etching, and logistical costs. Accordingly, perceiving an opportunity, many automotive dealers have made window etching available, at additional cost, to their customers as an add-on product.

Such dealers have been known to etch the unique 17 character Vehicle Identification Number (VIN) of a vehicle onto its windows. However, in order to practically utilize inexpensive acid-based etching techniques, a stencil or other template is required.

Such dealers have been known to have such disposable stencils produced, bearing a reverse of the VIN, as required. However, this is inconvenient, in terms of lost time and increased cost.

Template systems, which enable a stencil for any given VIN to be created on demand, are known in the prior art. U.S. Pat. No. 4,652,337 (Picone et al.), issued Mar. 24, 1987, is exemplary in this regard. However, such template systems are typically relatively complex.

Accordingly, it has become commonplace for dealers to purchase relatively inexpensive stencils bearing identification indicia other than the VIN; to etch the windows of customers who so wish with such stencils; and to maintain a registry of such indicia as applied. However, the “one-at-a-time” manner in which etching was carried out, coupled with the inconvenience of maintaining such registry, adds to the overall cost of the product, such that market penetration of the product when sold in this manner is relatively low.

### SUMMARY OF THE INVENTION

It is an object of the present invention to provide a business method which provides a profit center to automotive dealers.

It is another object of the present invention to provide a business method which offers the clientele of automotive dealers an opportunity to obtain benefits.

These and other objects are met by the present invention, a business method relating to the sale of intangible products.

As one aspect of the invention, an intangible product is sold by a vendor to an automotive dealer for substantially each vehicle in the inventory of such dealer, the intangible product being an entitlement in favour of the dealer or any transferee therefrom, or subsequent transferee.

The entitlement is irrevocably associated with said each vehicle, but is cancellable at the instance of the dealer in the event that the vehicle is made the subject of a dealer trade, whereupon the vendor reimburses the dealer for its purchase price of the product.

As another aspect of the invention, the intangible product is preferably a warranty against theft of said each vehicle.

As another aspect of the invention, the dealer is preferably obligated to perform a service in relation to each vehicle in its inventory.

As another aspect of the invention, the service is preferably an theft identification service.

As another aspect of the invention, the theft identification service is an etching service, whereby the dealer applies indicia to the windows of the vehicle when it enters the inventory of the dealer.

As another aspect of the invention, the dealer preferably provides information as to the indicia, and the vehicle to which same have been applied, to the vendor, who maintains a registry thereof.

As another aspect of the invention, the vendor provides the dealer with a system for warranty administration.

As another aspect of the invention, the system comprises a server connected to that portion of the Internet known as the World Wide Web, and which provides a platform, accessible over the World Wide Web, through which the dealer, using a personal computer, may access functions of the server, which functions include providing a mechanism for registering, canceling and transferring warranties to other client dealers.

As another aspect of the invention, the functions of the server further preferably include providing a mechanism for relaying to the vendor the identifying indicia, and the vehicle to which it has been applied.

As another aspect of the invention, the client dealers are preferably obligated to attempt to charge vehicle purchasers a fee for products and services provided to the purchaser, including the benefit of the warranty.

As yet another aspect of the invention, the vendor preferably arms the client dealer with promotional material describing the likelihood of a vehicle being made the subject of a theft and which explain the steps taken by the dealer to obtain the benefit of the warranty for the purchaser, specifically, the etching service, and the benefits afforded by the warranty.

As yet another aspect of the invention, the vendor instructs the client dealer in presentation techniques, whereby the intended purchaser of the vehicle perceives the warranty as a gift from the client dealer.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described hereinbelow.

### BRIEF DESCRIPTION OF THE DRAWINGS

A presently preferred embodiment of the invention will now be illustrated, with reference to the following illustrations, wherein:

FIG. 1 is a schematic view of the server of the preferred system, coupled through the Internet to web clients;

FIG. 2 is a view of a HOME PAGE communicated by the server;

FIG. 3 is a view of a LOG-IN PAGE communicated by the server;

FIG. 4 is a view of a USERNAME ALERT produced by the browser of a web client;

FIG. 5 is a view of a PASSWORD ALERT produced by the browser;

FIG. 6 is a view of a USERNAME ERROR PAGE communicated by the server;

FIG. 7 is a view of a PASSWORD ERROR PAGE communicated by the server;

FIG. 8 is a view of an ACCESS DENIED PAGE communicated by the server;

FIG. 9 is a view of a DATA ENTRY MENU FRAME communicated by the server;

FIG. 10 is a view of a STATIC FRAME communicated by the server;

FIG. 11 is a view of a REGISTRATION FRAME communicated by the server;

FIG. 12 is a view similar to FIG. 11, illustration embedded functionality of the REGISTRATION FRAME;

FIG. 13 is a view of a GLASS ID ALERT produced by the browser;

FIG. 14 is a view of a BLANK VIN ALERT produced by the browser;

FIG. 15 is a view of a STOCK ALERT produced by the browser;

FIG. 16 is a view of a MODEL ALERT produced by the browser;

FIG. 17 is a view of a VIN DIGIT ALERT produced by the browser;

FIG. 18 is a view of a VIN EXISTS FRAME communicated by the server;

FIG. 19 is a view of a VIN ILLEGAL FRAME communicated by the server;

FIG. 20,is a view of a REGISTRATION SUCCESSFUL FRAME communicated by the server;

FIG. 21 is a view of an EDIT SEARCH FRAME communicated by the server;

FIG. 22 is a view of a NO MATCH FRAME communicated by the server;

FIG. 23 is a view of a EDIT SEARCH RESULTS FRAME communicated by the server;

FIG. 24 is a view of a WARRANTY DETAILS FRAME communicated by the server;

FIG. 25 is a view of an EDIT RECORD FRAME communicated by the server;

FIG. 26 is a view of a CONFIRM EDIT FRAME communicated by the server;

FIG. 27 is a view of a WARRANTY UPDATE FRAME communicated by the server;

FIG. 28 is a view of a TRANSFER SEARCH FRAME communicated by the server;

FIG. 29 is a view of a TRANSFER SEARCH RESULTS FRAME communicated by the server;

FIG. 30 is a view similar to FIG. 29, showing embedded functionality of the TRANSFER SEARCH RESULTS FRAME;

FIG. 31 is a view of a CONFIRM TRANSFER FRAME communicated by the server;

FIG. 32 is a view of a WARRANTY TRANSFER FRAME communicated by the server;

FIG. 33 is a view of a CANCEL SEARCH FRAME communicated by the server;

FIG. 34 is a view of a CANCEL SEARCH RESULTS FRAME communicated by the server;

FIG. 35 is a view similar to FIG. 34, showing embedded functionality of the CANCEL SEARCH RESULTS FRAME;

FIG. 36 is a view similar to FIG. 35, showing further embedded functionality of the CANCEL SEARCH RESULTS FRAME;

FIG. 37 is a view of a CONFIRM CANCEL FRAME communicated by the server;

FIG. 38 is a view of a WARRANTY CANCEL FRAME communicated by the server;

FIG. 39 is a view of a REPORTS MANAGEMENTS FRAME communicated by the server;

FIG. 40 is a view of a RC REPORT DEFINITION FRAME communicated by the server;

FIG. 41 is a view similar to FIG. 40, showing embedded functionality of the RC REPORT DEFINITION FRAME;

FIG. 42 is a view similar to FIG. 41, showing further embedded functionality of the RC REPORT DEFINITION FRAME;

FIG. 43 is a view of a REGISTRATION REPORT produced by the browser;

FIG. 44 is a view of a TRANSFER REPORT DEFINITION FRAME communicated by the browser;

FIG. 45 is a view of a TRANSFER REPORT produced by the browser;

FIG. 46 is a view of a WARRANTY PRINT RANGE FRAME communicated by the server;

FIG. 47 is a view of a CHANGE PASSWORD FRAME communicated by the server;

FIG. 48 is a view of a PASSWORD CONFIRMATION ALERT produced by the browser; and

FIG. 49 is a view of a PASSWORD CHANGE CONFIRMATION FRAME communicated by the server.

### DETAILED DESCRIPTION OF A PREFERRED EMBODIMENT

A preferred embodiment of the present invention, a business method for use by a vendor, is hereinafter described.

### THEFT IDENTIFICATION

As one aspect of the business method, an automotive dealer (hereinafter, “client dealer”) is provided, free of charge, with a supply of stencils and a supply of acid from the vendor.

The vendor ensures that each stencil issued bears a sequence of indicia (typically, numbers) that is unique from all other stencils issued previously. In addition to the sequence, the stencil bears indicia identifying the vendor, typically, a toll-free phone number.

Each stencil includes 10 complete sets of the indicia, each set is suitable for use in acid etch process.

The client dealer is instructed by the vendor to ensure that all new and used vehicles in its inventory are theft-identified, and to thereafter theft-identify all incoming new and used vehicles.

“Theft identify”, as used above, means that the client dealer uses the acid, and a respective one of the stencils, to etch all major glass surfaces of a vehicle in its inventory with the indicia on said stencil. The respective stencil, including both used and unused portions, is destroyed after the vehicle is theft-identified, to avoid the potential for inadvertent re-use.

### UNREGISTERED WARRANTIES

In accordance with another aspect of the business method, intangible products, namely, warranties, are sold by the vendor to the client dealer. Warranties are sold to the client dealer in lots of 50. Possession in a warranty is transferred by the vendor by providing to the client dealer a warranty number. The vendor maintains a list, to ensure that each warranty number provided is unique as compared to all other numbers provided earlier.

### REGISTRATION

The client dealer relays to the vendor, in relation to each vehicle etched, the indicia borne by the stencil used, the Vehicle Identification Number, the model of the vehicle, the stock number assigned by the dealer to the vehicle, and a warranty number, selected from the list of warranty numbers earlier provided to the client dealer.

When this is completed, the warranty is said to have been “registered” against that vehicle. Each warranty can be registered only once.

### REGISTERED WARRANTIES

Under the terms of each warranty, if the vehicle against which it has been registered is stolen and not returned, or returned as a total loss, as determined by the insurance company for the owner of the vehicle at the time of such theft, compensation equal to the actual market value of the vehicle, up to a first specified maximum, typically $ 5000, is obligated to be provided by the vendor to said owner, which obligation is V underwritten by a licensed insurance carrier.

In the preferred embodiment (“Standard” Warranties), the compensation is in the nature of cash or cash equivalents. In an alternative embodiment (“Split” Warranties), the compensation is split between cash or cash equivalents and a coupon, redeemable in the purchase of a replacement vehicle from the client dealer. In the event that the coupon is redeemed, the vendor is obligated to provide compensation to the client dealer equal to the redemption value of the coupon.

In both the preferred and the alternative embodiment, if the vehicle is recovered and deemed repairable, compensation is provided to match the comprehensive deductible up to a second specified maximum, typically $ 500, on the same terms as previously described in relation to a total loss.

The obligation of the vendor is contingent upon the client dealer having permanently etched all major glass of the vehicle as instructed, and is also made the subject of various exclusions and limitations. For example, all warranties of merchantability or fitness for a particular purpose are disclaimed, as is all liability for any incidental or consequential damages arising from theft of the vehicle or for amounts in excess of the first and second specified maximums, as applicable.

As well, no compensation is payable for a total loss unless the theft has been reported to the client dealer, and unless the vendor has been provided with: (1) confirmation that the theft has been reported to the police by providing date of loss and the police occurrence number; (2) proof that the owner's insurance company has made a full and final claim settlement for the total loss of the vehicle under the comprehensive section of the owner's insurance policy, as well as a copy of the insurance company cheque, or, in the event that primary insurance coverage is not in force, a copy of the police report; and (3) proof of ownership.

Further, no compensation is payable for a partial loss unless the vendor has been provided with (1) a copy of the police report; (2) a copy of the comprehensive deductible amount; (3) a copy of a repair order by a licensed new car dealership; and (4) a copy of the vehicle ownership. As well, no payments will be made if the owner intentionally conceals or misrepresents any material fact or circumstances relating-to the disappearance of the vehicle.

The warranty expires four years from the date of its registration.

### INSTRUCTIONAL METHODS

The benefit of a registered warranty runs with the vehicle, such that there is no requirement or other obligation upon the client dealer to provide details to the vendor as to the identity of any purchaser of the vehicle. There is similarly no per se requirement to affirmatively sell the warranty to the purchaser; the warranty has already been attached to the vehicle. However, the client dealer must recover its direct expenses relating to the warranty, as well as its indirect expenses, relating to the etching.

Towards this purpose, client dealers are instructed to charge vehicle purchasers a fee.

To limit the number of instances wherein payment of the fee is refused by vehicle purchasers, the vendor arms the client dealer with promotional material describing the likelihood of a vehicle being made the subject of a theft and which explain the steps taken by the dealer to obtain the benefit of the warranty for the purchaser, specifically, the theft-identification service, and the benefits afforded by the warranty. Such material is provided for placement at the desk of each salesperson, and also in a plaque form, at several strategic, highly visible locations within the premises of the client dealer. In the event that a transferee of the vehicle contemplates not paying the fee, it is advantageous to indicate to it that a waiver needs to be signed, assigning the benefit of the warranty to the dealer. This signifies to the purchaser of the vehicle that there is value to the warranty, and that the costs paid by the dealer for the warranty cannot be avoided.

### CANCELLATION

Warranties may be cancelled if the vehicle is to be made the subject of a fleet or wholesale sale, or a trade to an automotive dealer that is not a client dealer. To effect cancellation, the client dealer need only advise the vendor of the warranty number which is sought to be cancelled, whereupon the vendor provides the client dealer a credit note for the purchase of another warranty.

### TRADE BETWEEN CLIENT DEALERS

If the vehicle against which a warranty is registered is made the subject of a trade between two client dealers, the warranty registered against said vehicle can be transferred with the vehicle; the vendor need only be provided with the number of the warranty registered against the vehicle, and particulars of the transferring and receiving client dealers.

If only one vehicle that is the subject of a trade has a warranty registered thereagainst, the client dealers may arrange amongst themselves for compensation to the transferring dealer. If both vehicles in the trade have warranties registered thereagainst, the registered warranties may be swapped, along with the vehicles.

### ADMINISTRATION SYSTEM

As yet another aspect of the invention, as part of the business method, client dealers are provided, free of charge, with a system for warranty administration.

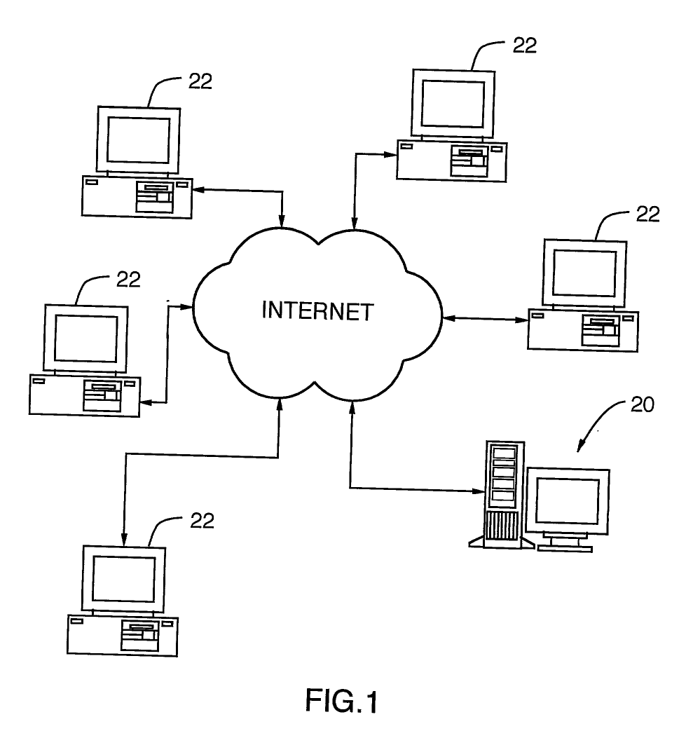

As illustrated in FIG. 1, the preferred system comprises a server 20 that is connected to that portion of the Internet known as the World Wide Web (the Web). The server includes secure data storage.

The server 20 is a computer that is executing Web server software and database software, and is operated by a third party application service provider. The server 20 is adapted to communicate through the Web with multiple web clients 22, shown in FIG. 1, each of the type comprising a personal computer based on the microprocessors sold by Intel Corporation under the trade-mark Pentium®, using the operating system sold by Microsoft Corporation in association with the trade-mark Windows® and running the Web browser sold by Microsoft Corporation in association with the trade-mark Internet Explorer®, as well as the report engine sold by Crystal Decisions, Inc., under the trade-mark Crystal Reports®. The server 20 is adapted to so communicate with the web clients 22 by way of hypertext markup language compliant pages and frames.

The secure data storage includes a user database, a dealer database, a warranty database, a transfer log, and a VIN rule database.

The warranty database includes fields for dealership, warranty number, registration date, expiration date, last record modification, glass ID number, VIN, stock number, model, make and warranty type and warranty cancellation reason.

The dealer database includes fields for warranty type and warranties left in inventory.

The user database includes fields for username, password access level (full, limited, administrator) and dealership.

The transfer log includes fields for warranty, transferor, transferee and date.

The VIN rule database includes fields for each of the 17 characters of a VIN, and is populated with data which permits a VIN to be decoded, as is publicly available from the Society of Automotive Engineers.

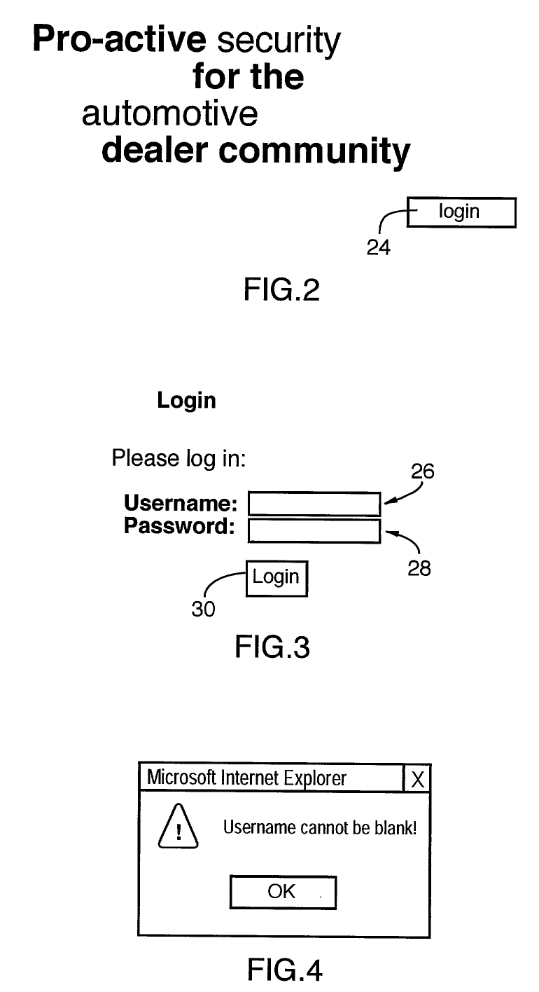

FIG. 2 shows a HOME PAGE that is presented to a web client which has accessed the server.

In order to access the secure data storage or the database software from the HOME PAGE, a visitor to the site, such as a client dealer, is required to select a LOG-IN link 24 found on the HOME PAGE. Selecting the LOG-IN link 24 causes the server to create an error log associated with the web client in the secure data storage, and also causes the server to forward to the web client a LOG-IN PAGE, as shown in FIG. 3.

The LOG-IN PAGE has embedded instructions which trigger the web client browser to produce text input elements wherein a username and a unique user identification password may be entered, indicated by general reference numerals 26, 28, respectively.

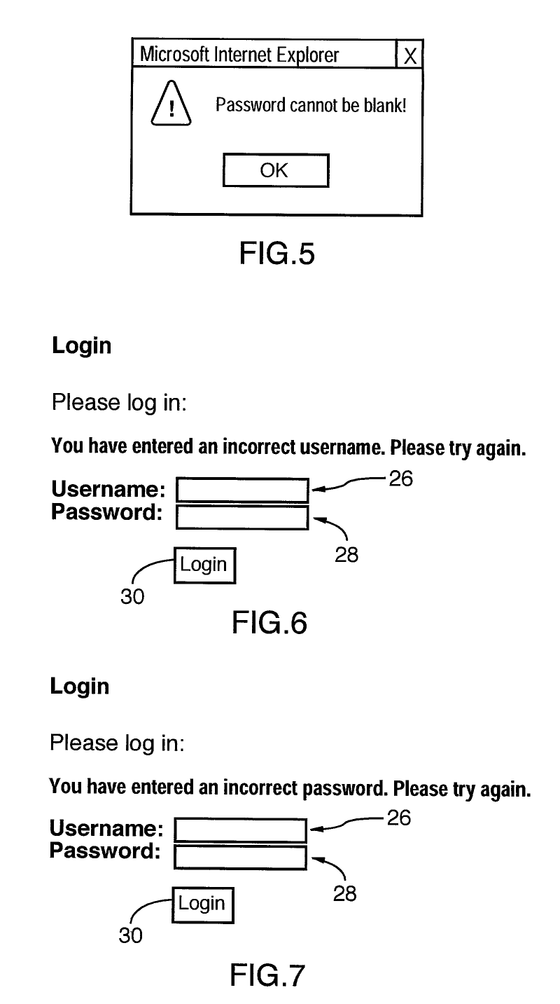

The embedded instructions also include limiting criteria for input elements 26,28, specifically, that same cannot be submitted when empty, such that an attempt to enter same when empty causes the browser to produce a corresponding alert, as shown in FIGS. 4, 5.

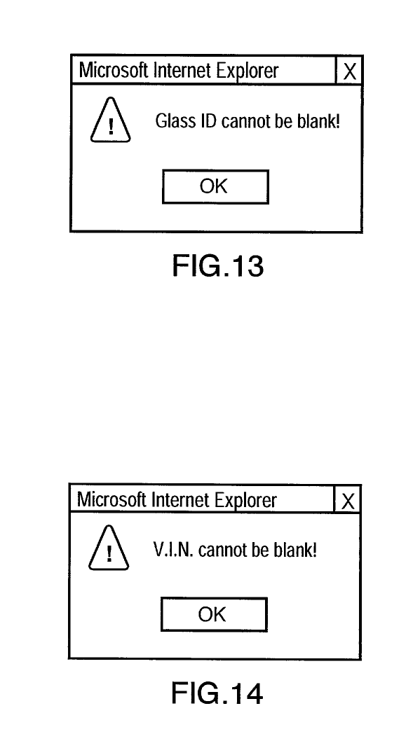

The embedded instructions also trigger the web client browser to produce a submission element 30, shown in FIG. 13, which, when selected, packages the frame into a query and forwards same to the server 20 (provided the aforementioned limiting criteria are satisfied).

Data so received is compared by the server 20 against username and password combination in the user database.

If no match for the username entered by the visitor is found, the server 20 reads the error log. If the error log is less than two, the server 20 writes to the error log to increase its value by one, presents to the web client a USERNAME ERROR PAGE, as shown in FIG. 6, and permits the visitor a further opportunity to enter a username and password combination, as aforementioned.

If the username matches a username in the secure data storage, but there exists no match for the password entered, the server 20 reads the error log. If the error log is less than two, the server 20 writes to the error log to increase its value by one, and presents to the web client a PASSWORD ERROR PAGE, shown in FIG. 7, and permits the visitor a further opportunity to enter a password, in the manner aforediscussed.

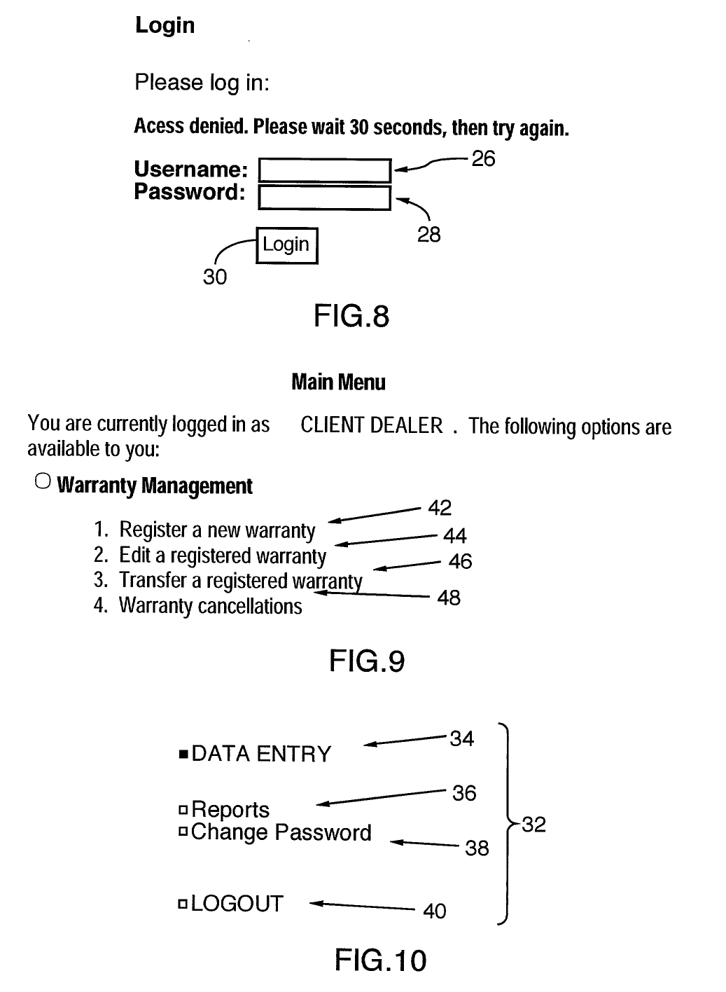

In the event of a mismatch, of the username entered, the password entered or both, in circumstances wherein the error log is two, the server 20 writes a zero to the error log; forwards an ACCESS DENIED PAGE as shown in FIG. 8 to the web client; and starts a timer.

The ACCESS DENIED PAGE includes embedded functionality to provide for entry of a username and password in the manner previously discussed. However, while the timer is running, any further attempt to enter username and password causes the server 20 to forward the ACCESS DENIED PAGE to the web client. After 30 seconds have elapsed, the timer stops running and is reset.

### FULL ACCESS USERS

Once a valid username and password combination has been entered by a full access user, the server 20 forwards to the web client a DATA ENTRY MENU FRAME, as shown in FIG. 9, and also forwards a STATIC FRAME, shown separately in FIG. 10, to the web client. The STATIC FRAME is included in each page communicated by the server 20 to a logged-in web client, and includes a secondary navigation menu, designated by general reference 32, which includes a link, designated with reference numeral 34, to the DATA ENTRY MENU FRAME shown in FIG. 9, as well as a REPORTS MANAGEMENT FRAME link 36, a CHANGE PASSWORD FRAME link 38 and a LOGOUT element 40.

### DATA ENTRY

As illustrated in FIG. 9, the DATA ENTRY MENU FRAME includes a REGISTRATION FRAME link 42; an EDIT SEARCH FRAME link 44; a TRANSFER SEARCH FRAME link 46; and a CANCELLATION SEARCH FRAME link 48.

### REGISTRATION

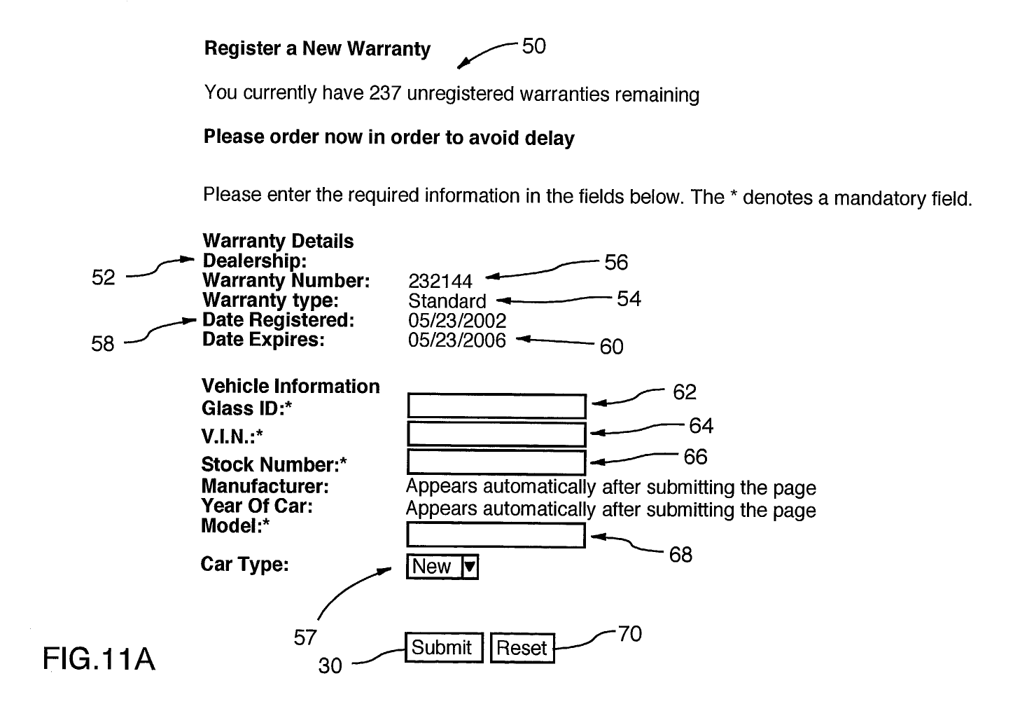

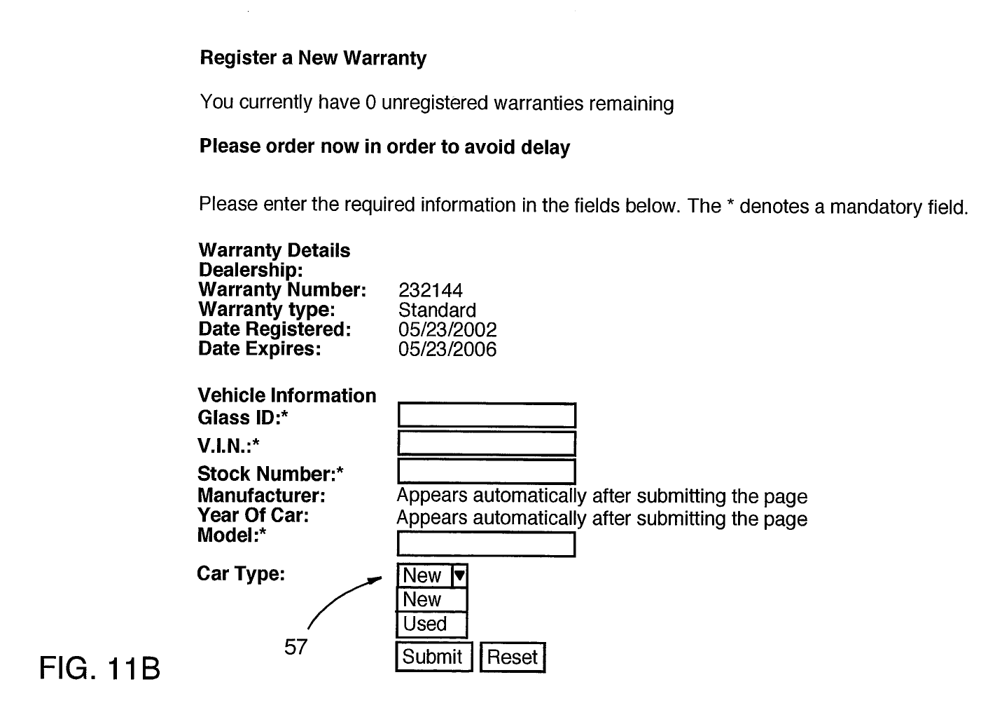

Following the REGISTRATION FRAME link 42 causes the server 20 to forward a REGISTRATION FRAME, shown in FIG. 11, to the web client.

The REGISTRATION FRAME displays the number of warranties left in the inventory of the dealership associated with the user (“unregistered warranties”), as indicated by general reference numeral 50, which information is extracted from the dealer database, specifically, from the records of that dealer which the user database indicates the user to be associated with. In the event that the inventory of the dealership includes less than 15 unregistered warranties, a modified PROMPT FRAME is forwarded, as shown in FIG. 11A, wherein the visitor is urged to contact the vendor to purchase more warranties.

Also displayed is information relating to the dealership with which the user is associated, specifically, the dealership name and the type of warranty which the dealership sells (Standard or Split), as indicated by 52 and 54, respectively. This latter information is extracted from the user database and the dealer database. The REGISTRATION FRAME also displays the next available unregistered warranty in the inventory of the dealership, as indicated by 56, as well as the current date 58 and a date four years following, as indicated by 60.

Thus, the REGISTRATION FRAME displays all information pertaining to an unregistered warranty, but for Glass ID, VIN, stock number, car model and car type.

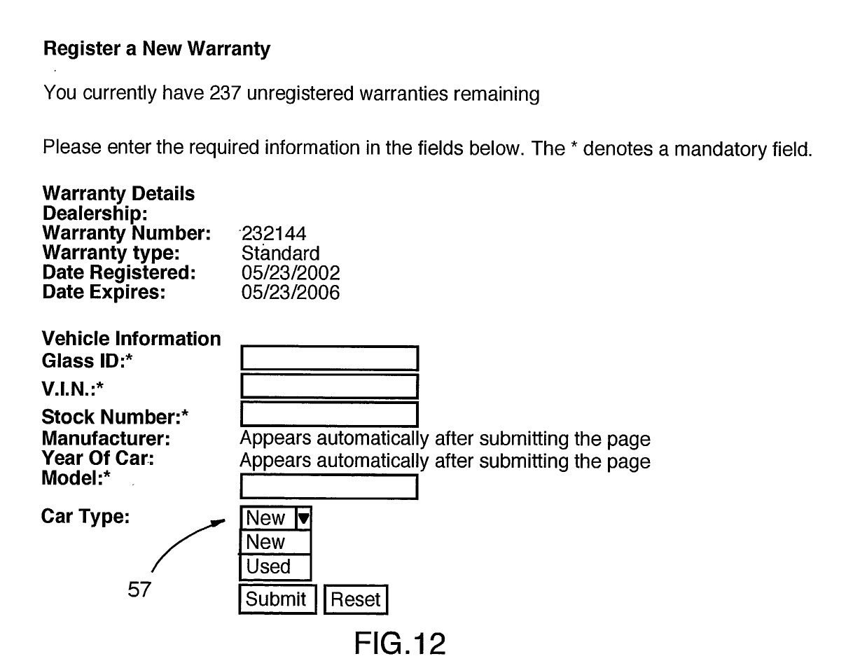

The REGISTRATION FRAME also includes embedded functionality to provide data entry elements for entry of Glass ID, VIN, stock number and car model, as indicated by 62, 64, 66, 68, respectively, as well as a pull-down menu 57, to simplify indication of car type (new or used), as indicated by FIG. 12. Also provided is a submission element 30, as well as a reset element 70, which clears all data entry elements 62, 64, 66, 68.

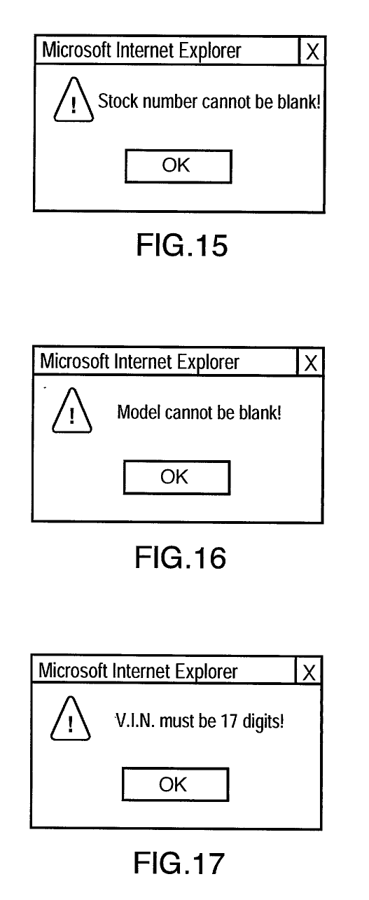

Limiting criterion, as discussed more fully earlier in relation to the LOG-IN PAGE (FIG. 3) are provided for the data entry elements 62, 64, 66, 68, such that the browser is instructed to provide suitable alerts in the event that empty elements are attempted to be submitted, as indicated by FIGS. 13-16, or in the event that a VIN having other than 17 characters is entered, as indicated by FIG. 17.

Upon submission, by selection of submission element 30 in the REGISTRATION FRAME (FIG. 11), of data meeting the defined limiting criterion, the server ascertains if the VIN entered is valid, using the VIN database, and also compares the VIN entered against others in the warranty database. The server also ascertains if there are any warranties left in the inventory to register. If there are no warranties left, the server forwards the REGISTRATION FRAME (FIG. 11) to the visitor, which indicates that there are no unregistered warranties remaining (see reference 50).

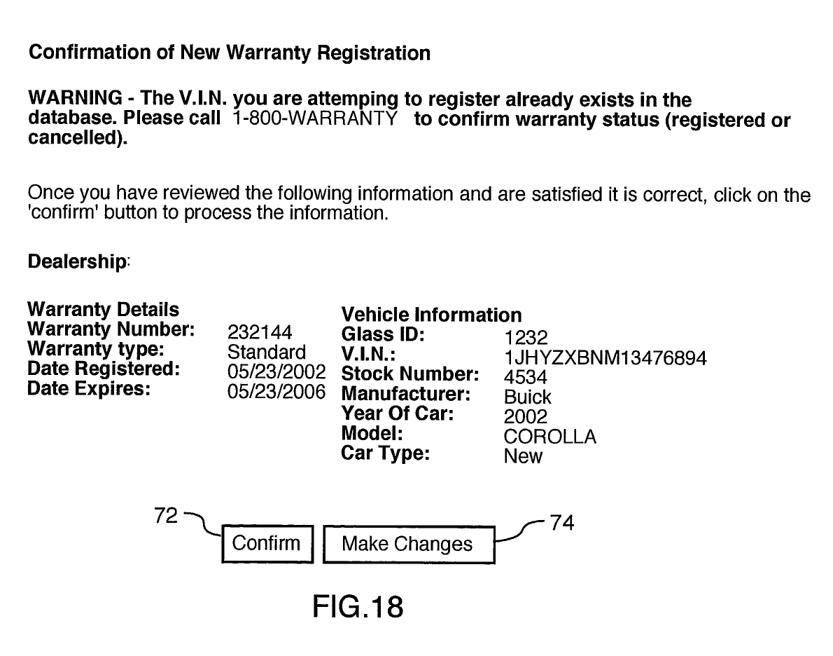

If the VIN entered is identical to a VIN previously entered, the server forwards a VIN EXISTS FRAME to the web client, as shown in FIG. 18, to the web client, indicating as such, and providing a summary of the data with respect to the warranty in question. The VIN EXISTS FRAME includes elements to confirm the data as entered, or make changes, indicated by 72 and 74, respectively.

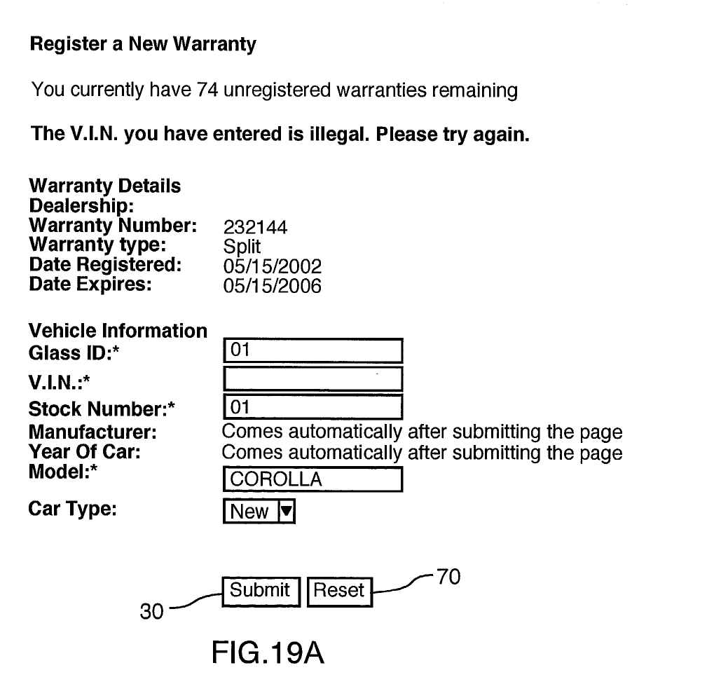

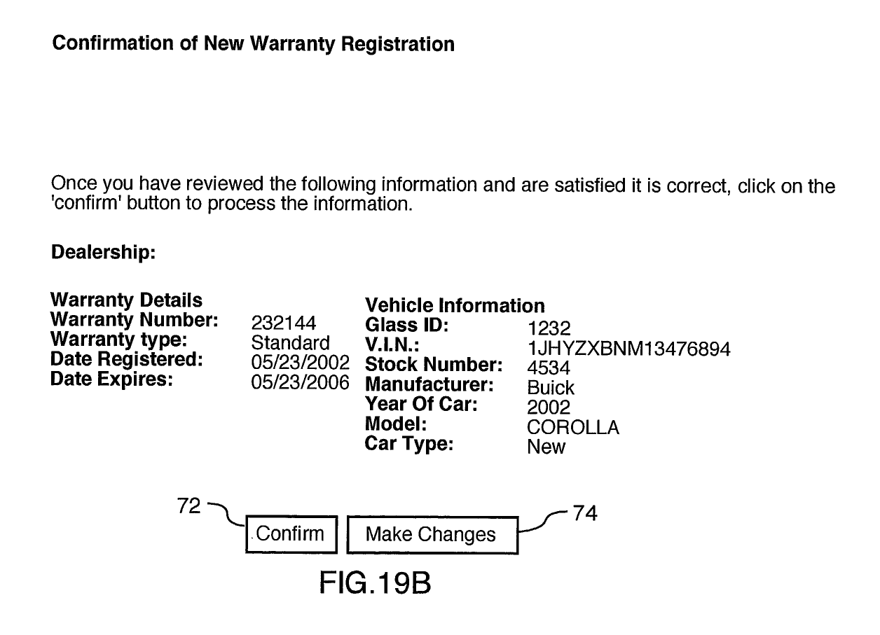

If the VIN entered is invalid, the server similarly prepopulates the REGISTRATION FRAME shown in FIG. 11 with data and also adds a warning thereto, as shown in FIG. 19, before forwarding same to the web client for editing and resubmission as previously discussed.

If the VIN entered does not match any other VIN in the database, the server forwards a CONFIRM REGISTRATION FRAME, as shown in FIG. 19B. The CONFIRM REGISTRATION FRAME includes elements to confirm the data as entered, or make changes, indicated by 72 and 74, respectively.

Selecting element 74 causes the server to prepopulate the REGISTRATION FRAME shown in FIG. 11 with data as entered by the user, and forward same to the web client, for editing and submission as previously discussed.

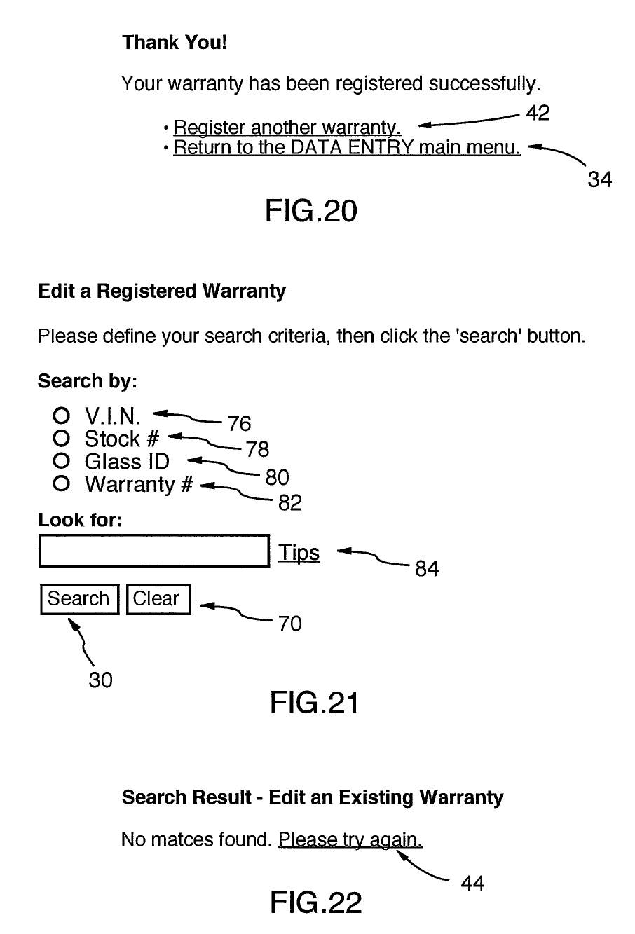

After a valid data set has been submitted, by selecting element 72, the server writes the data set to the warranty database, and forwards a confirmation page to the web client, as shown in FIG. 20, which includes a DATA ENTRY MENU FRAME link 34 and a REGISTRATION FRAME link 42.

### EDITING

Following the EDIT SEARCH FRAME link 44 from the DATA ENTRY MENU FRAME (FIG. 9) causes the server to forward an EDIT SEARCH FRAME to the web client, as shown in FIG. 21, which includes embedded functionality that causes the browser to produce checkbox elements for each of VIN, Stock #, Glass ID and Warranty Number, indicated by 76,78,80,82 respectively, as well as a data entry element 84, a submission element 30 and a reset element 70. In the EDIT SEARCH FRAME, a visitor may select a field in the warranty database to be searched, by checking the appropriate checkbox; may enter a search term in data entry element 84; and may submit the search to the server by agency of submission element 30.

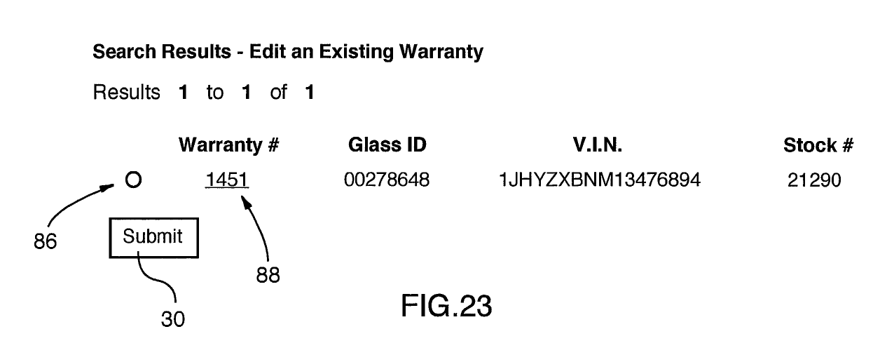

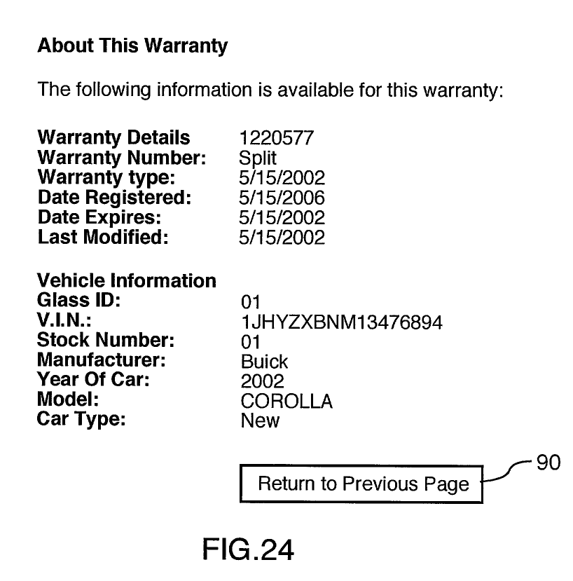

If no matches are found which correspond to the search, the server forwards a NO MATCH FRAME, as shown in FIG. 22, to the web client, which includes an EDIT SEARCH FRAME link 44. If a match or matches are found, the server presents an EDIT SEARCH RESULTS FRAME, as shown in FIG. 23, which includes embedded functionality which causes the web client to display the results of the search and produce a checkbox 86 for each record disclosed (in the figure, only one element is shown, but it should be understood that, in the event that multiple matches are found, multiple checkboxes 86, to correspond with the matches, will be A illustrated). The web client provides the user an opportunity to select one of the matches, by selecting the respective checkbox, and submitting the selection by element 30. Links 88 are provided to each of the records disclosed by the search, which, if followed, cause the server to forward a WARRANTY DETAILS FRAME, as shown in FIG. 24, which displays particulars of the selected warranty, as well as an EDIT SEARCH RESULTS FRAME link 90.

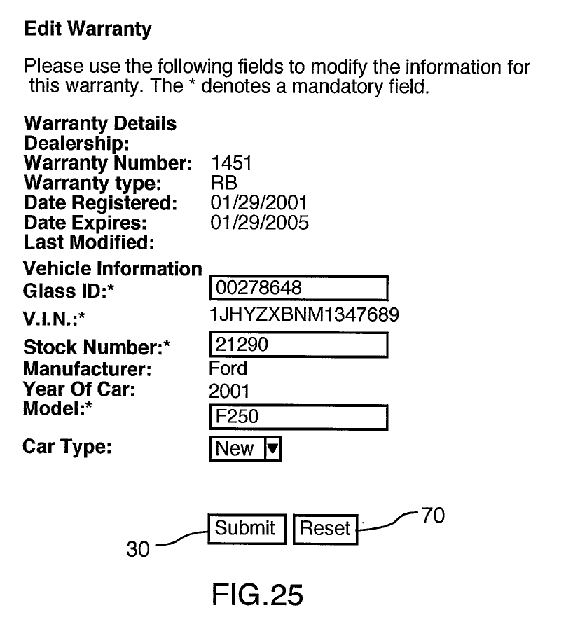

Submitting a selection from the EDIT SEARCH RESULTS FRAME (FIG. 23) causes the web client to forward to the server a command, in response to which the server forwards to the web client an EDIT RECORD FRAME, shown in FIG. 25, prepopulated with data from the warranty database pertaining to the selection, wherein the user may make changes using the web client, for submission to the server.

The data set is checked by the server, and the visitor is suitably prompted by the web client to enter a valid data set, in a manner substantially identical to that employed during the initial registration process.

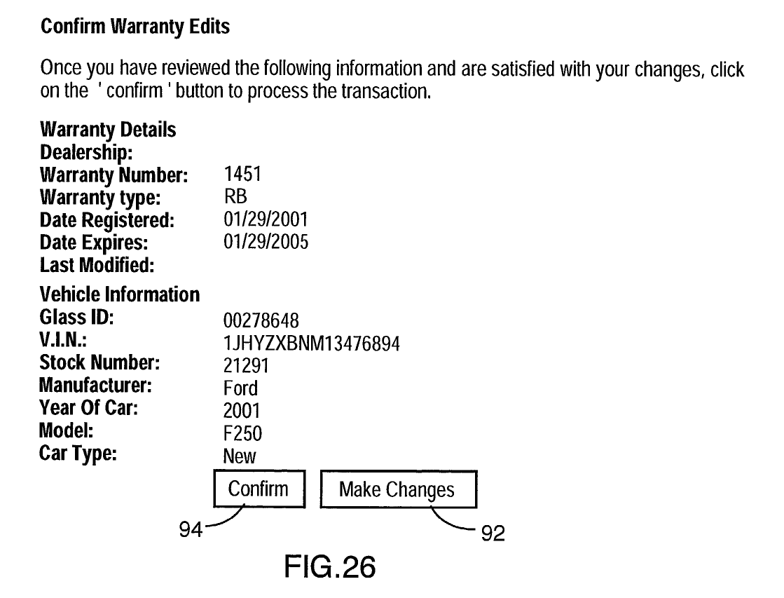

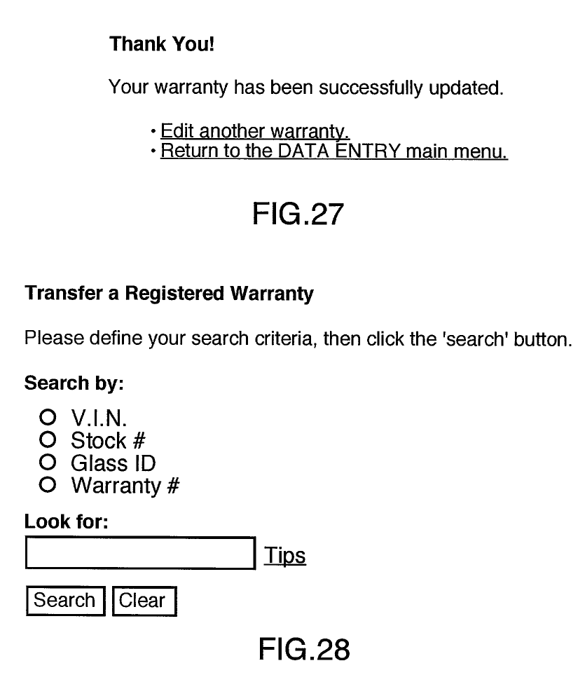

Upon the submission of a valid data set by submission element 30, the server forwards a CONFIRM EDIT FRAME, shown in FIG. 26, to the web client which includes particulars of the data set entered, as well as a link 92 back to the EDIT RECORD FRAME, and a CONFIRM link 94. Following the CONFIRM EDIT link 94 causes the server to forward a WARRANTY UPDATE FRAME, shown in FIG. 27, to the web client, which confirms that the edits have been incorporated into the database, and includes a EDIT SEARCH FRAME link 44, as well as a DATA ENTRY MENU FRAME link 34.

### TRANSFER

Following the TRANSFER SEARCH FRAME link 46 from the DATA ENTRY MENU FRAME (FIG. 9) causes the server to forward a TRANSFER SEARCH FRAME, as illustrated in FIG. 28, which permits a user to search the warranty database and select a record, in the manner previously discussed with reference to FIGS. 21-22.

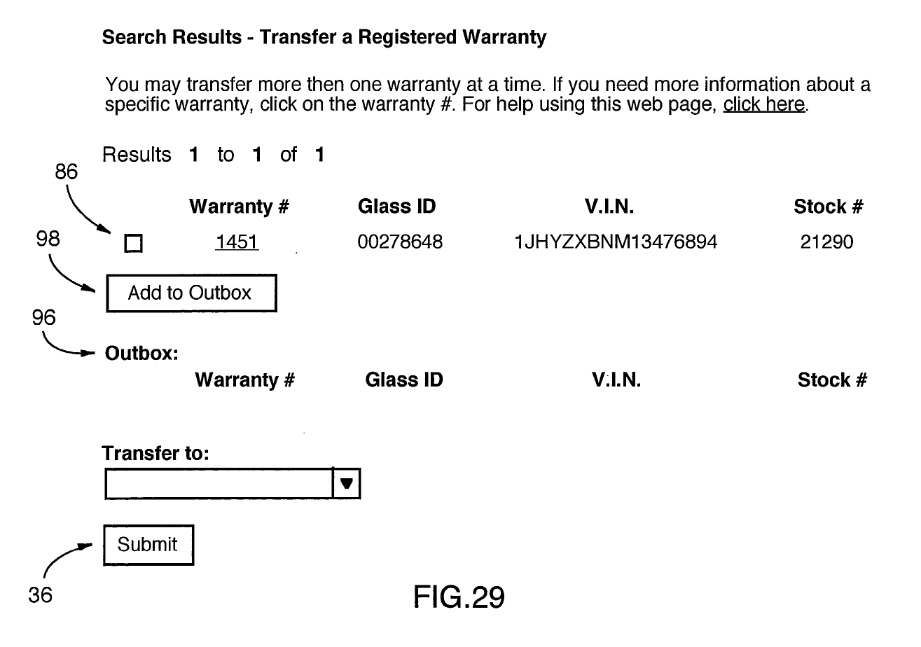

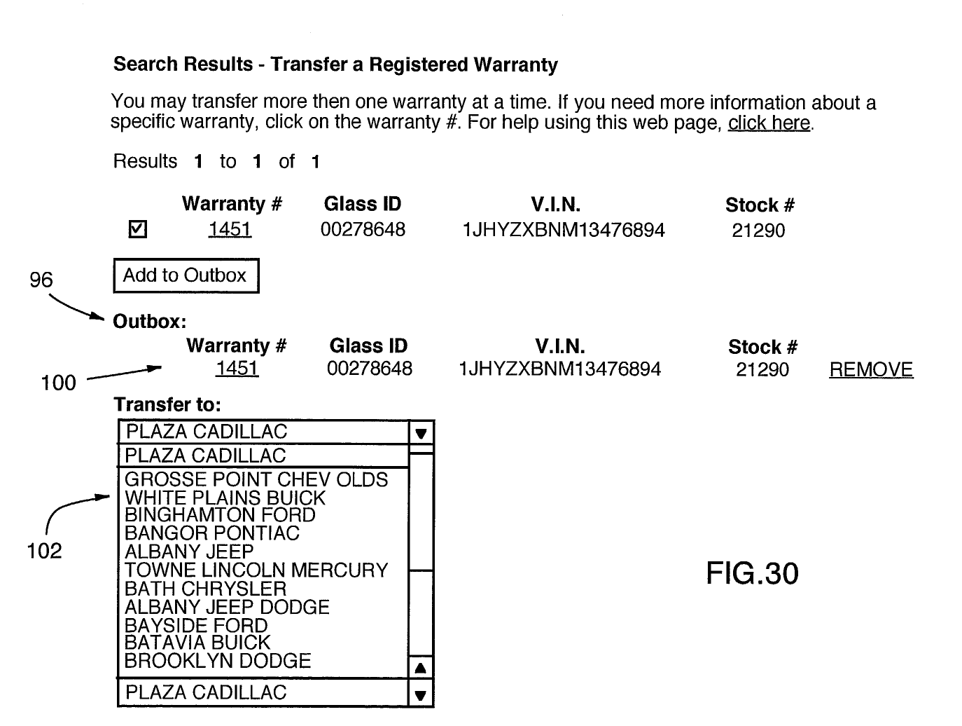

Upon submission of a search having matches, the server forwards a TRANSFER SEARCH RESULTS FRAME, shown in FIG. 29, showing details of the warranties disclosed by the search. The TRANSFER SEARCH RESULTS FRAME has embedded functionality which permits the user add one or more of such disclosed warranties to an outbox 96, by providing a checkbox element 86 for each match, which may be highlighted by the user, and then transferred to outbox 96 by an adding element 98. This prompts the server to update the TRANSFER SEARCH RESULTS FRAME, as shown in FIG. 30, wherein details 100 of warranties to be transferred are shown in outbox 96.

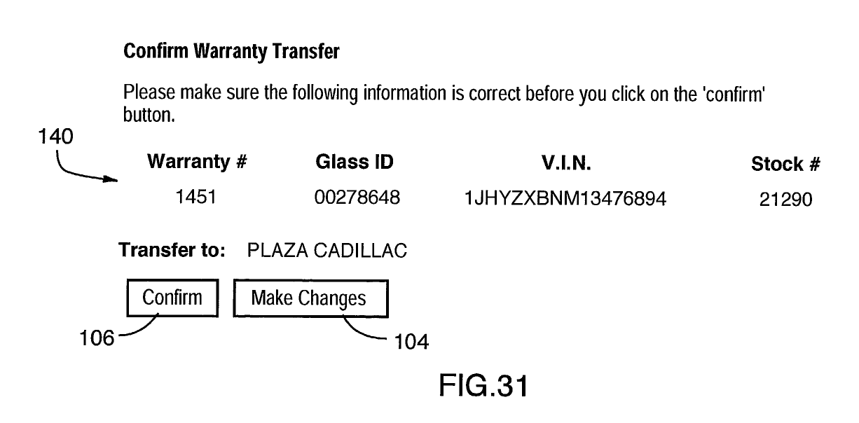

The user is also provided an opportunity by the web client to direct the contents of the outbox 96 to another dealer, selected using a drop-down menu 102 provided. Drop-down menu 102 is prepopulated with names of client dealers which may be selected, as illustrated in FIG. 30. Submission of the selection by the user, by submission element 30 (illustrated in FIG. 29) causes the server to forward to the web client a CONFIRM TRANSFER FRAME, shown in FIG. 31, which shows details 140 of the warranties selected, as well as the participating dealer 142 to which the warranties will be transferred, and includes a link 104 back to the TRANSFER SEARCH RESULTS FRAME (FIG. 29), as well as a confirm element 106.

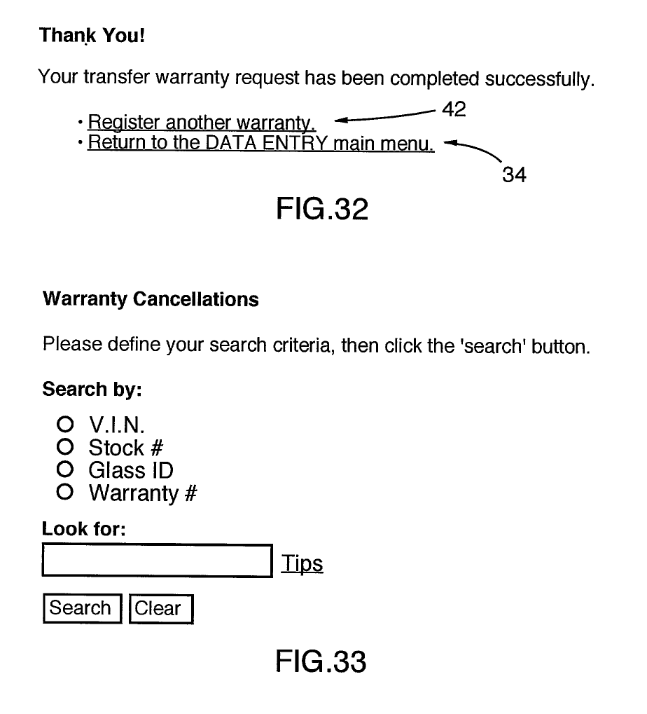

Selection of the confirm element 106 causes the server to write a data set reflecting the transfer to the warranty database and the transfer log, and forwards a WARRANTY TRANSFER FRAME to the web client, as shown in FIG. 32, which includes a TRANSFER SEARCH FRAME link 46 and a DATA ENTRY MENU FRAME link 34.

### CANCELLATION

Following the CANCELLATION SEARCH FRAME link 48 from the DATA ENTRY MENU FRAME (FIG. 9) causes the server to forward a CANCEL SEARCH FRAME, shown in FIG. 33, which permits a user to search the warranty database and select a record, in the manner previously discussed with reference to FIGS. 21-22.

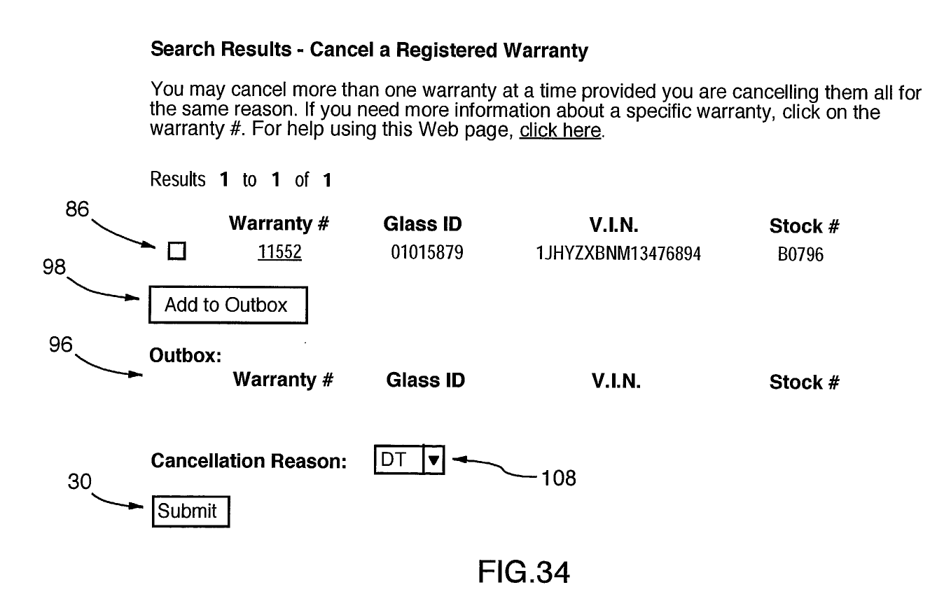

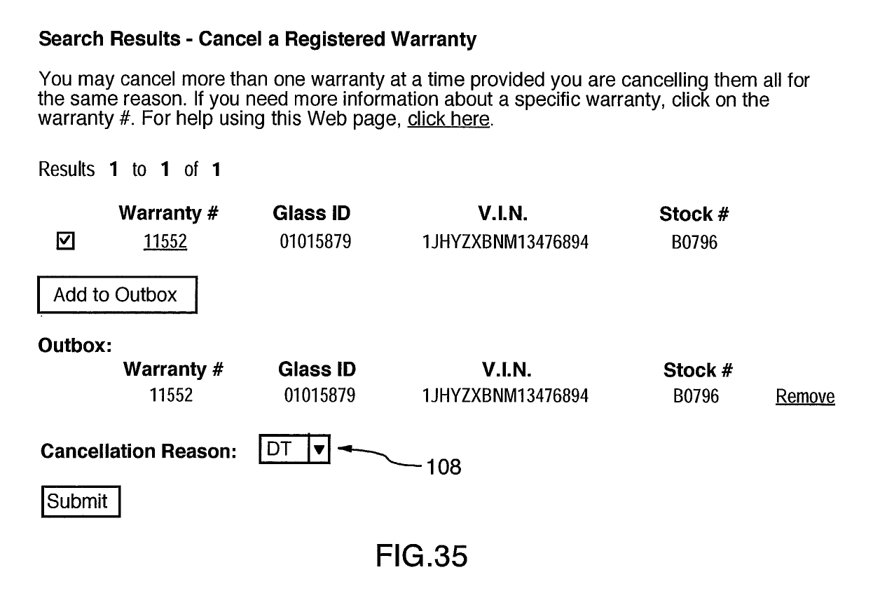

Upon submission of a search having matches, the server forwards a CANCEL SEARCH RESULTS FRAME, shown in FIG. 34, showing details of the warranties disclosed by the search, which permits the user add one or more of such disclosed warranties to outbox 96, by highlighting the associated selection elements 86, through the use of an adding element 98, as more fully discussed in relation to FIG. 29 earlier.

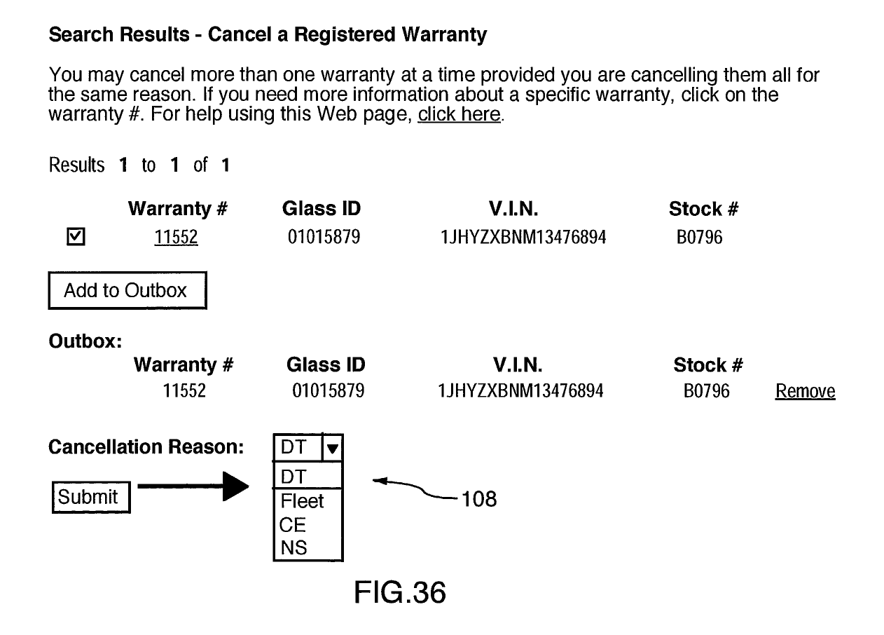

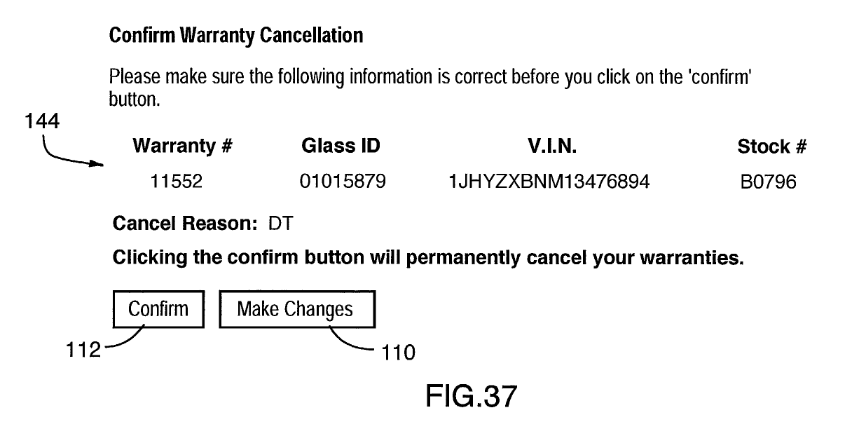

The user is also provided an opportunity by the web client to identify a reason for cancellation for the entire set of warranties selected, using a drop-down menu 108 provided, as best illustrated in FIG. 36. (DT=dealer trade; Fleet is fleet sale; CE=clerical error; NS=no sale). Submission of the selection by element 30 causes the server to forward to the web client a CONFIRM CANCEL FRAME, shown in FIG. 37, which shows details 144 of the warranties selected, as well as the reason for the cancellation 146, and includes a link 110 back to the CANCEL SEARCH RESULTS FRAME (FIG. 34), as well as a confirm element 112.

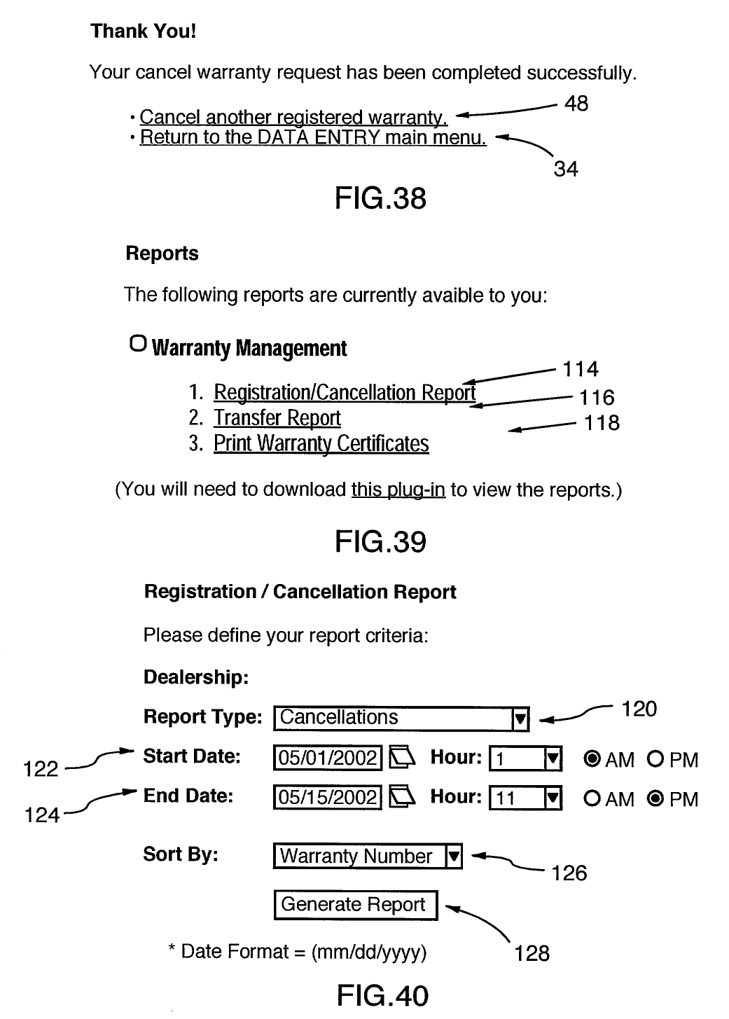

Selection of the confirm link 112 causes the web client to forward a command to the server, whereupon the server writes a data set reflecting the cancellation to the warranty database, and forwards a WARRANTY CANCEL FRAME to the web client, as shown in FIG. 38 which includes a CANCEL SEARCH FRAME link 48 link and a DATA ENTRY MENU FRAME link 34.

### REPORTS

Following the REPORT QUERY FRAME link 36 from the secondary navigation menu 32 in the STATIC FRAME (FIG. 10) causes the server to forward to the web client a REPORTS MANAGEMENT FRAME, shown in FIG. 39, which includes an RC REPORT DEFINITION FRAME link 114, a TRANSFER REPORT DEFINITION FRAME link 116, and a WARRANTY PRINT RANGE FRAME link 118.

Following the RC REPORT DEFINITION FRAME link 114 causes the server to forward to the web client a RC REPORT DEFINITION FRAME, shown in FIG. 40, which permits the user to tailor a desired report using the web client. More specifically, the user can select from report formats including cancellations only, registrations only or registrations and cancellations, using a drop-down menu 120, as best illustrated in FIG. 40 and FIG. 42.

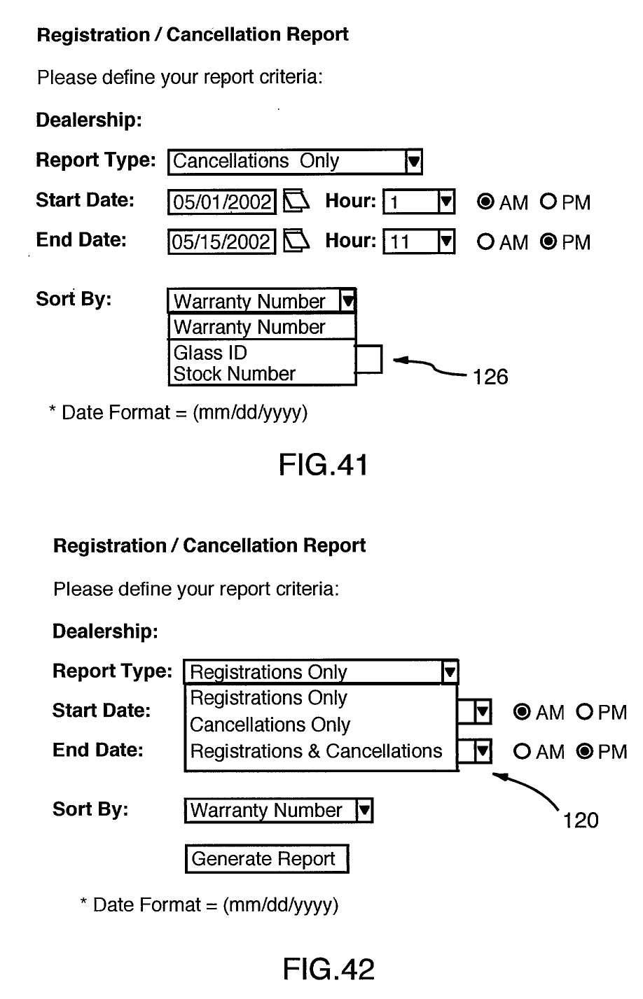

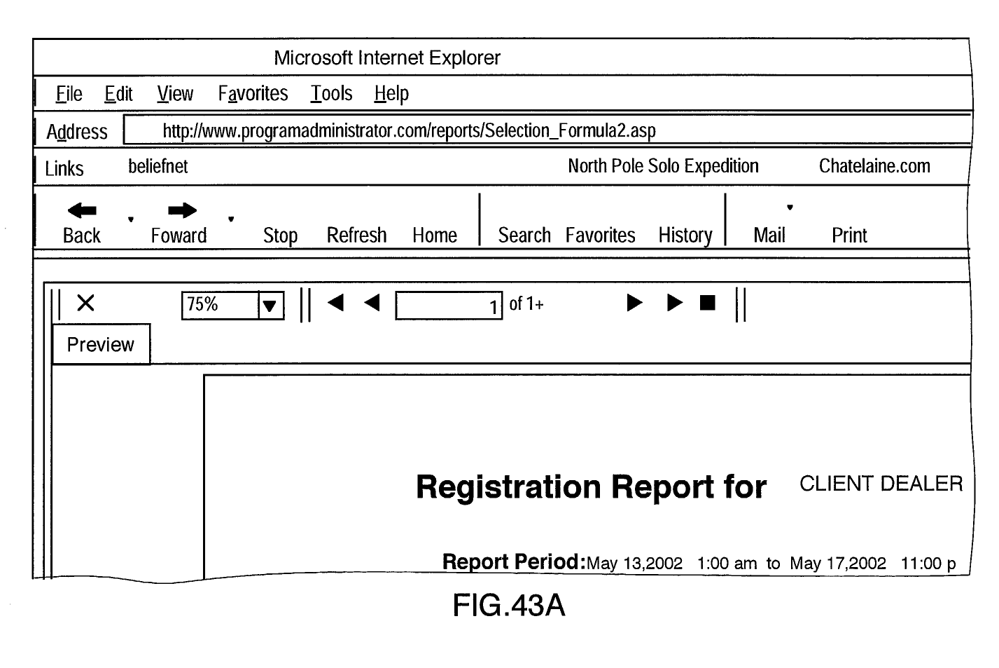

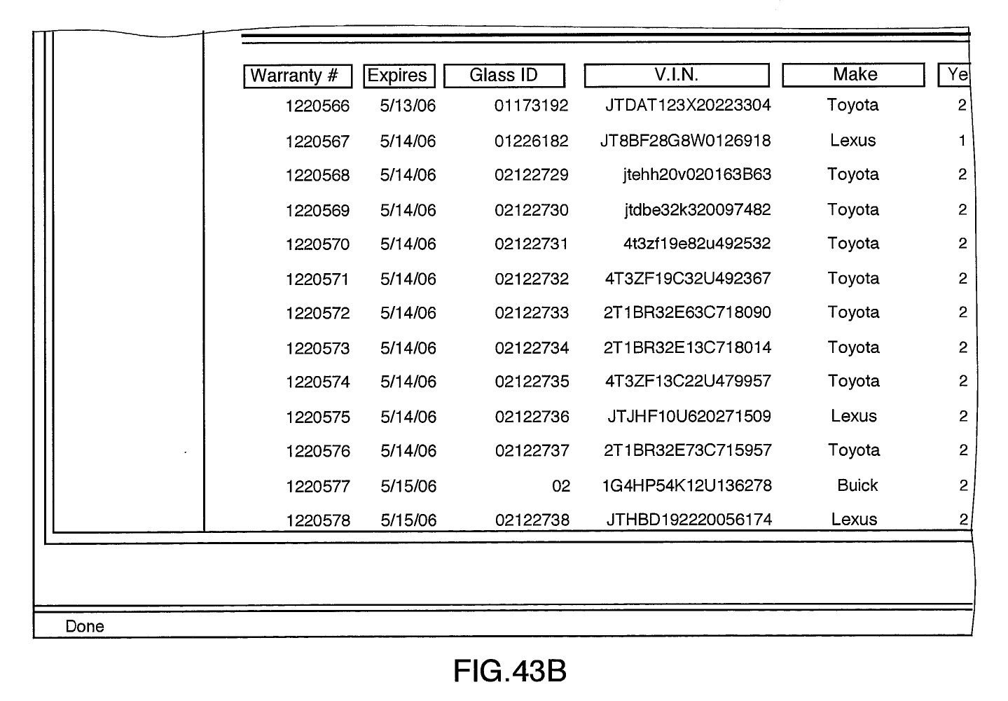

The user can also enter start dates and times, and end dates and times, using corresponding text input fields 122, 124 produced by the web client, as well as define the field by which the data is to be sorted (selected from warranty number, glass ID, and stock number) using drop-down menu 126 as best shown in FIG. 40 and FIG. 41. Once a report format has been tailored, selection of a form generate element 128 on RC REPORT DEFINITION FRAME (FIG. 40) causes the web client to send to the server a command, which activates the database software and searches the warranty database for records which fall within the selected criteria. The relevant records are forwarded to the web client in a format suitable for review by the Crystal Reports® report engine, and this application is booted up on the web client to display the data, as shown in FIG. 43.

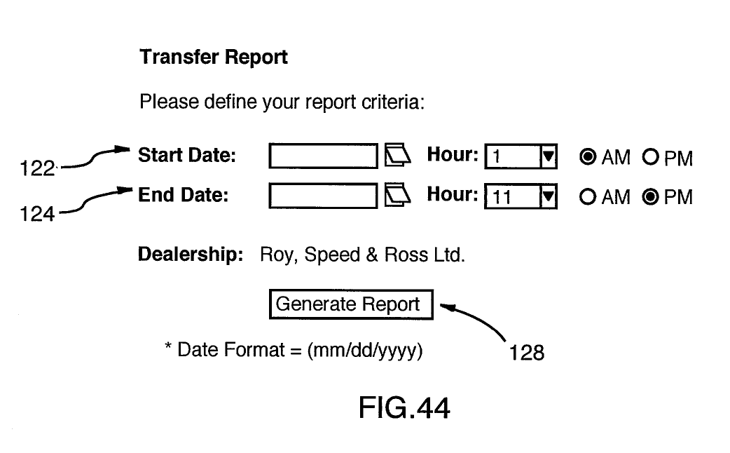

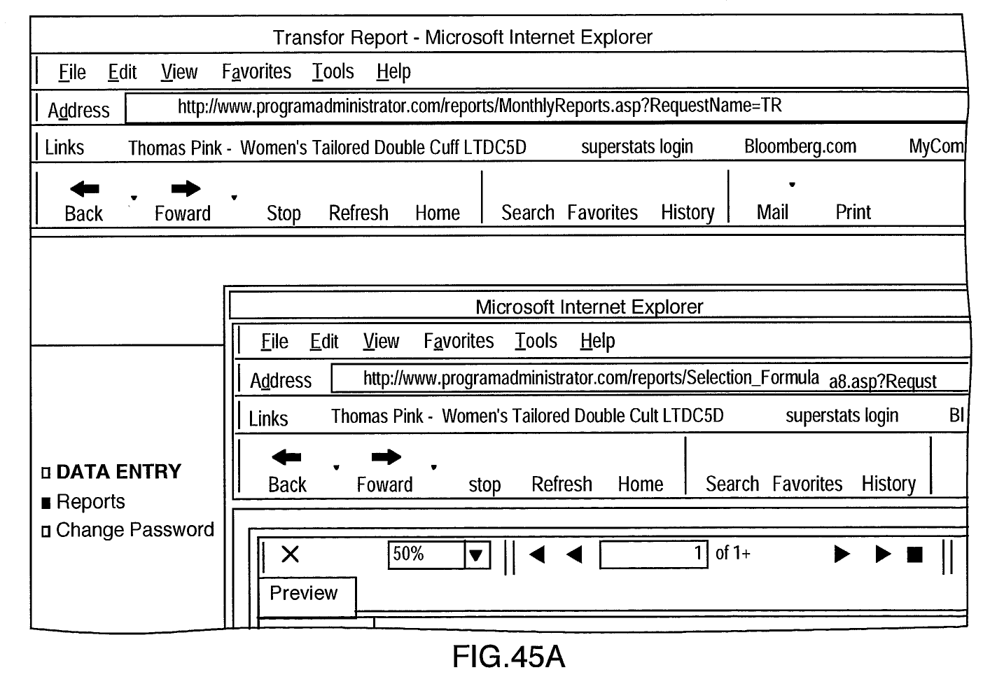

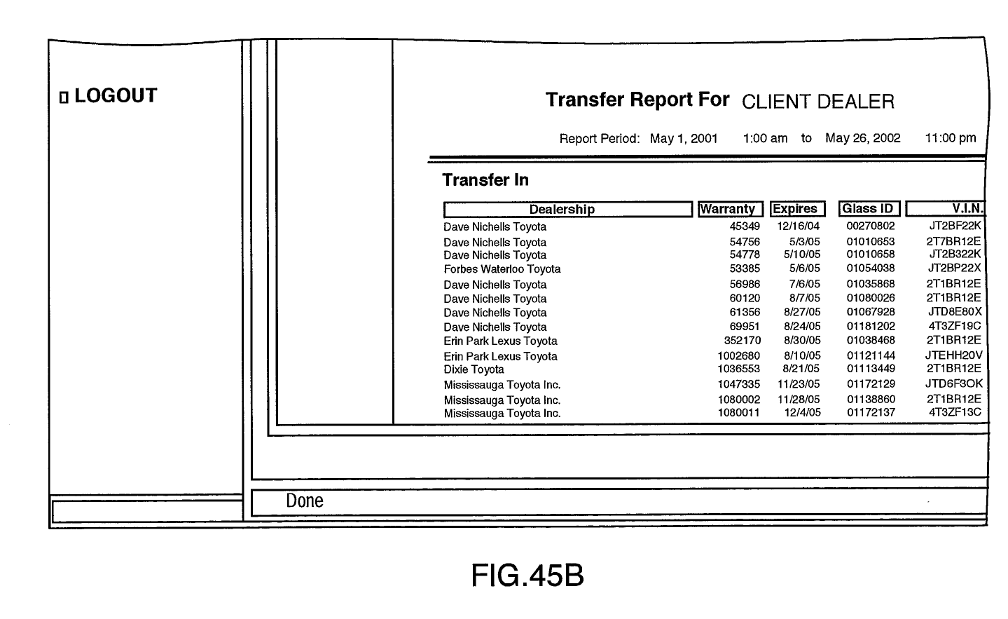

Following the TRANSFER REPORT DEFINITION FRAME link 116 from the REPORTS MANAGEMENT FRAME (FIG. 39) causes the server to forward to the web client a TRANSFER REPORT DEFINITION FRAME, as shown in FIG. 44, which permits the user to tailor a desired report using the web client. More specifically, the user can enter start and end dates and times using text entry blocks 122, 124 produced by the web client, as previously discussed in relation to FIG. 40. Once a report has been tailored, selecting the form generate element 128 on TRANSFER REPORT DEFINITION FRAME causes the web client to send to the server a command which activates the database software and searches the warranty database for records which meet the defined criteria, which are forwarded to the web client in a format suitable for review by the Crystal Reports® reports engine, which application is booted up on the web client to display the collected data, as shown in FIG. 45.

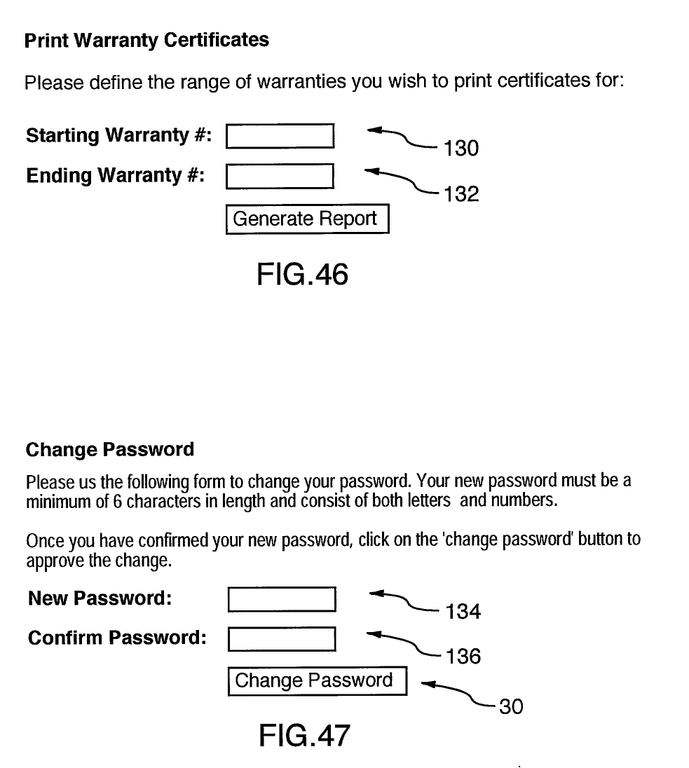

Following the WARRANTY PRINT FRAME LINK 118 from the REPORTS MANAGEMENT FRAME (FIG. 39) causes the server to forward to the web client a WARRANTY PRINT RANGE FRAME, as shown in FIG. 46, which permits the user to tailor a desired report using the web client. More specifically, the user can enter a starting warranty number and an ending warranty number, using text entry elements 130, 132, produced by the web client. Once a range has been specified, selecting the form generate element 128 on the WARRANTY PRINT RANGE FRAME causes the web client to send to the server a command which activates the database software and searches the warranty database for records which fall within the criteria. The relevant records are forwarded to the web client in a format suitable for review by the Crystal Reports® reports engine, which application is booted-up on the web client to display the collected data. The viewer is tailored to display the data in the format of a Warranty Certificate, tailored to the specific needs and tastes of the vendor.

The certificates may be printed by the client dealer and distributed to the purchaser of the vehicle. Appropriate certificate paper is provided to the client dealers by the vendor for this purpose.

### PASSWORD

Following the CHANGE PASSWORD FRAME link 38 from the secondary navigation menu 32 in the STATIC FRAME (FIG. 10) causes the server to forward a CHANGE PASSWORD FRAME, shown in FIG. 47, to the web client, whereupon the visitor may use the web client to enter a new password and a confirmation password, using password elements 134, 136 produced by the browser, in combination with a submission element 30.

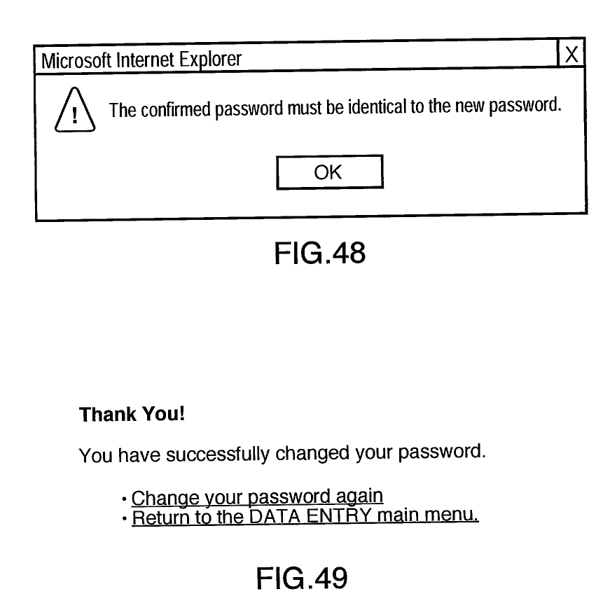

In the event that the new password and the confirmation password entered are not identical, the web client creates a suitable alert, shown in FIG. 48.

If the new password and the confirmation password are identical, the new password is forwarded to the server, which writes same to the user database in the secure data storage, and forwards a PASSWORD CHANGE CONFIRMATION FRAME, shown in FIG. 49, to the web client which includes links to the change password page and to the main menu page.

### LOGOUT

Following the logout link causes the server to forward the home page to the web client, from which log-in must be repeated in order to gain access to the functionality of the site, as aforediscussed.

### LIMITED ACCESS USERS

Limited access users are not permitted to access the Data Manipulation functions of the home page, and, upon log-in, are directed to the REPORTS MANAGEMENT FRAME shown in FIG. 39, as opposed to the DATA ENTRY MENU FRAME which full access users are met with upon log-in. Attempts by limited access users to access the data entry functions cause the server to forward an access denied page, which advises the user as such. Limited access functionality is advantageously provided to personnel is a dealership who would benefit from access to the sales statistics, such as sales personnel, but do not need access to data manipulation functions, so as to limit the number of persons accessing the data and better safeguarding against the possibility of data corruption. Also, it also provides for the possibility of some dealers, who wish to utilize paper records, to operate a paper-based system of administering sales, while at the same time, having access to sales statistics.

### ADMINISTRATOR

It will be understood to persons of ordinary skill in the art that the vendor will be required to access the databases from time to time to set-up passwords and usernames for persons who are to be authorized to utilize the system. The server permits this level of access to users having administrator status in the user database.

As well, it will be understood that the vendor will need to access the database to assign warranties to client dealers (ie to place them in inventory), as they are purchased. Typically, such purchase will be made by a telephone or facsimile order initiated by the client dealer, followed by an entry into the database to reflect the warranties issued and a conventional paper invoice issued by the vendor relating to the purchase.

The transfer and cancellation reports features provide a ready mechanism to establish, for any given dealer, the number of warranties canceled; this number can be utilized by the vendor to produce a suitable credit note, for application against such invoices.

Various modifications and alterations may be used in the design and manufacture of the business method according to the present invention without departing from the spirit and scope of the invention.

For example, only, whereas the preferred administration system of the present invention contemplates warranties being registered by the dealers from their inventory, it is possible that the system could be modified, such that warranties were registered by the dealers directly from the inventory of the vendor, and a corresponding entry made to the account of the dealer, for subsequent periodic billing.

As well, whereas in the preferred embodiment, theft identication of the vehicles is carried out through acid etching process, other identification mechanism, such as non-removable stickers, ultra-violet paint marking, or the like, could be employed.

As well, it is possible that warranties could be ordered on-line, and paid for via some method of secure online payment.

Yet further, whereas the preferred embodiment relates to a warranty against theft, other warranties, such as warranties against vehicle breakdown, could be used with utility. As well, other types of intangible products could be utilized.

Additionally, whereas the preferred embodiment contemplates the provision of etching services, other services could be employed, such as vehicle inspections or detailing.

As well, it would be noted that notwithstanding in the preferred embodiment, the VIN database is used to prepopulate various fields, so as to provide a convenient cross-reference to the user, to ensure that the VIN is correct for the vehicle, this feature need not be incorporated.

Accordingly, it should be understood that the scope of the present invention is to limited only by the accompanying claims, purposively construed.

We claim:

1. A business method wherein an intangible product is sold by a vendor to an automotive dealer for substantially each vehicle in the inventory of such dealer, such intangible product being an entitlement in favour of the dealer or any transferee therefrom, or subsequent transferee, wherein the entitlement is irrevocably associated with said each vehicle and is cancellable at the instance of the dealer in the event that the vehicle is made the subject of a dealer trade, whereupon the vendor reimburses the dealer for its purchase price of the product.

2. A business method according to claim 1, wherein the intangible product is a warranty against theft of said each vehicle.

3. A business method according to claim 2, wherein disclosure of information as to the purchaser of said each vehicle to the vendor is not made nor required.

4. A business method according to claim 1, wherein the dealer is obligated to perform a service in relation to each vehicle in its inventory.

5. A business method according to claim 1, wherein the dealer is obligated to person a service in relation to the vehicle in order for the entitlement to be in effect.

6. A business method according to claim 5, wherein the service is a theft-identification service, whereby the dealer applies indicia to the windows of the vehicle when it enters the inventory of the dealer.

7. A business method according to claim 6, wherein the indicia are applied by an acid etch process.

8. A business method according to claim 7, wherein the dealer provides information as to the indicia, and the vehicle to which same have been applied, to the vendor, who maintains a registry thereof.

9. A business method according to claim 8, wherein the vendor provides the dealer with a system for warranty administration.

10. A business method according to claim 9, wherein the system comprises a server connected to that portion of the Internet known as the World Wide Web, and which provides a platform, accessible over the World Wide Web, through which the dealer , using a personal computer, may access functions of the server, which functions include providing a mechanism for registering, canceling and transferring warranties to other client dealers.

11. A business method according to claim 5, wherein the vendor provides the dealer with a system for warranty administration.

12. A business method according to claim 11, wherein the system comprises a server connected to that portion of the Internet known as the World Wide Web, and which provides a platform, accessible over the World Wide Web, through which the dealer, using a personal computer, may access functions of the server, which functions include providing a mechanism for registering, canceling and transferring warranties to other client dealers.

13. A business method according to claim 12, wherein the functions of the server further include providing a mechanism for relaying to the vendor the identifying indicia, and the vehicle to which it has been applied.

14. A business method according to claim 1, wherein client dealers are obligated to attempt to charge vehicle purchasers a fee.

15. A business method according to claim 13, wherein the vendor arms the client dealer with promotional material describing the likelihood of a vehicle being made the subject of a theft and explaining the steps taken by the dealer to obtain the benefit of the warranty for the purchaser, specifically, the theft-identification service, and the benefits afforded by the warranty.
